(19) United States
(12) Patent Application Publication
(10) Pub. No.: US 2008/0221222 A1
(43) Pub. Date: Sep. 11, 2008

(54) Disinfectant

(75) Inventors: Gisela Greif, Remagen (DE); Robrecht Froyman, Monheim (DE); Claudio Ortiz, Monheim (DE); Gerd-Friedrich Renner, Kurten (DE); Otto Exner, Ratingen (DE); Dietmar Schlegel, Leverkusen (DE); Rolf Matysiak, Duisburg (DE)

Correspondence Address: BAYER HEALTHCARE LLC, P.O.BOX 390, SHAWNEE MISSION, KS, 66201, US

(73) Assignees: BAYER HEALTHCARE LLC, LEVERKUSEN (DE); LANXESS DEUTSCHLAND GMBH, LEVERKUSEN (DE)

(21) Appl. No.: 11/995,995

(22) PCT Filed: Jul. 6, 2006
(86) PCT No.: PCT/EP2006/006599

§ 371 Date: Feb. 21, 2008

(30) Foreign Application Priority Data
Jul. 19, 2005 (DE) 102005033496.2

(51) Int. Cl. A01N 31/08; A01P 1/00

(52) U.S. Cl. 514/737

(57) ABSTRACT

The invention relates to a disinfectant which comprises a special combination of biocidal phenols and, where appropriate, phenol derivatives and a keratolytic. The disinfectant is particularly suitable for controlling parasitic protozoa including their persistent forms.

The invention relates to a disinfectant which comprises a special combination of biocidal phenols and, where appropriate, phenol derivatives and a keratolytic. The disinfectant is particularly suitable for controlling parasitic protozoa including their persistent forms.

Such disinfectants are particularly important, for example, for controlling coccidioses in productive animals. Eimeria tenella is the protozoan pathogen which gives rise to avian coccidiosis, a disease which has become economically important in conjunction with the intensive floor management of chickens and hens. Infection of the animals begins after they have taken up sporulated oocysts, which are the carriers of the infectious unicellular sporozoites. The sporozoites colonize intestinal cells under whose protection the parasitic stages are propagated in their millions. The pathology of a coccidial disease includes bloody diarrhoea, which can cause great economic loss due to the hens reducing their nutrient uptake and losing weight.

Coccidiostats to an annual value of at least 350 million US dollars are currently being expended for the prophylaxis of this disease. Since 1970, chemotherapeutic treatment has been carried out using the polyether ionophores monensin, narasin, salinomycin and lasalocid, in particular. Apart from the severe drug burden on the hen, the development of drug resistances is regarded as being the greatest problem associated with the chemotherapeutic treatment. The first indication of the development of resistance is frequently a renewed increase in oocyst excretion.

An alternative to the chemotherapeutic treatment of coccidioses would be early disinfection of the poultry buildings. In these buildings, the persistent eimeria stages, i.e. what are termed the oocysts, are deposited together with the animals' excrement and can persist, together with excrement residues and feed constituents, on floor coverings and partition surfaces, in wall cracks and on housing installations and, as a constant source of infection, give rise to fresh disease over a long period of time in the animals which are being used. Eimeria oocysts can still be infectious for up to a year after they have been excreted. The spreading of oocysts by people or animals into adjacent poultry buildings which occurs over this period of time constitutes an additional problem.

Eimeria tenella oocysts are 24.5-18.3 μm in size and are formed in their millions following the asexual propagation cycles which take place in the intestinal cells of infected animals. A female macrogamont is fertilized by a male microgamete and forms the zygote, which surrounds itself with two typical layers: a smooth outer layer which develops after fusion of the I wall forming bodies (WFIs) and an inner layer, which develops after fusion of the II wall forming bodies (WFIIs). Until both layers have been completed, the maturing oocysts remain in the parasitophorous vacuoles of infected intestinal cells and are only subsequently excreted together with the faeces. What is termed sporulation then begins in the presence of oxygen: four sporocysts, each of which contains two sporozoites, are formed from the undifferentiated sporont by way of reductive division. In the case of Eimeria tenella, sporulation as a rule takes 2-3 days. It is only after it has been completed that the oocyst is infectious.

The construction and composition of the two oocyst walls confer on them outstanding biochemical and physiological resistance, thereby making the walls into an effective protective barrier for ensuring the survival of the parasitic organisms in the open. While the outer oocyst wall is composed of phospholipids, long-chain alcohols and triglycerides, the inner layer consists of glycoproteins which are stabilized by disulphide bridges. The main oocyst-wall protein, which is 12-14 kDa in size, contains serine, tyrosine and threonine amino acids and is bonded to carbohydrates. These proteins provide the oocyst with great structural stability towards heat or cold. The lipids in the outer layer determine the high degree of resistance to chemicals.

Simple physical disinfection measures using heat, cold, desiccation or irradiation are only of very limited use: thus, while oocysts are destroyed in a few minutes at temperatures of 60-100° C. in the laboratory, the disinfectant effect of hot water is usually slight under practical conditions in the housing, since the water cools rapidly on the housing floor. High-pressure cleaning also only achieves partial disinfection when exposure times are short. The oocysts are also markedly resistant to cold. Emeria oocysts survive, and remain infectious, even after having been deep-frozen at −25° C. for 14 days. While desiccation achieves a certain degree of damage, the method has not been found to be particularly reliable for disinfection purposes.

While gamma and electron radiation of 3.5-4.0 kGy and upwards results in the oocysts losing their ability to sporulate, using such radiation is not a practical proposition for the farmer due to the high costs of acquiring the requisite equipment.

Most chemical disinfectants which are effective against bacteria and viruses are ineffective against Eimeria oocysts because the walls of the latter have a more complex chemical composition and impede the penetration of chemicals. A parasite-specific disinfectant has first of all to penetrate through the lipid-containing outer walls of the oocyst and, after that, to attack the stable glycoproteins of the inner walls before it can damage membrane-containing sporocysts and sporozoites.

Emeria oocysts are 1000 times more resistant than bacteria towards aggressive inorganic substances such as sodium hydroxide solution (NaOH) or sodium hypochlorite (NaOCl). The infectivity of the oocysts is not lost even at concentrations of >5% and an exposure time of 120 min. While ammonia (NH₃) is occasionally used with success in East European countries when the exposure time is 24 hours, the ammonia-saturated atmosphere at the same time constitutes a very severe olfactory nuisance.

Ethanol (70-90%) and formaldehyde do not have any effect on the resistant oocysts of Eimeria species which is adequate for practical purposes.

It is only derivatives of phenol, in particular p-chloro-m-cresol, which are present as the sole organic active compounds in some commercial preparations (Table 1), as well as also being present in combination with carbon disulphide and chloroform (Table 1). These derivatives are in practice used for controlling poultry coccidioses in empty housings.

TABLE 1
Approved disinfectants which are active against Eimeria oocysts (Böhm
2000)

| Trade Name | Active compounds | Application (%, h) |
|---|---|---|
| Calgonit sterizid P24 | Cresols | 4%, 2 h |
| Desssau DES SPEZIAL N | Cresols | 4%, 2 h |
| ENDOSANFORTE S Neu | Cresols | 4%, 2 h |
| JEME ®-OKOK 5 | Phenol compounds | 5%, 2 h |
| | Carbon disulphide | |
| | Chloroform | |
| LOMASEPT ® L 20 | Phenol compounds | 5%, 2 h |
| | Carbon disulphide | |
| | Chloroform | |
| NEOPREDISAN 135-1 | Cresols | 4%, 2 h |
| NOACK-DES ENDO | Cresols | 4%, 2 h |

WO 94/17761 describes a disinfectant having parasiticidal activity which comprises one or more phenols in combination with keratolytically active organic acids, ethylene glycol dialkyl ethers and sodium or potassium alkyl sulphonates or sulphates.

In Germany, the activity of antiparasitic disinfectants on Eimeria tenella oocysts is tested, in a suspension experiment (lysis test) and in an infection test on hen chicks, in accordance with the Germany Veterinary Society (DVG) guidelines. Eimeria tenella oocysts of the “Houghton” strain are categorized as being particularly resistant and are therefore recommended as test organisms.

While controlling oocysts of the Eimeria species is a special problem in practice, the structure of the cyst wall is similar in other protozoa, in particular coccidia, and also in worms. The preceding account, which takes Eimeria species as an example, can therefore also be applied to these organisms.

When using these test systems, we have now found, surprisingly, that the disinfectant activity of compositions which comprise a combination of different biocidal phenols or phenol derivatives while at the same time using keratolytics markedly exceeds that of existing disinfectants.

The invention therefore relates to:

a disinfectant which comprises
(a) a chlorinated biocidal phenol,
(b) another chlorinated or unchlorinated biocidal phenol,
(c) another unchlorinated biocidal phenol and/or a phenol derivative, and
(d) a keratolytic.

Biocidal phenols are understood as being phenol compounds which carry a free OH group and exhibit a biocidal effect. These phenols may carry additional ring substituents such as halogens, in particular chlorine, C₁₋₆-alkyl, C₃₋₆-cycloalkyl, phenyl, chlorophenyl, benzyl and/or chlorobenzyl.

Examples of unchlorinated biocidal phenols are: 2-methylphenol, 3-methylphenol, 4-methylphenol, 4-ethylphenol, 2,4-dimethylphenol, 2,5-dimethylphenol, 3,4-dimethyl-phenol, 2,6,-dimethylphenol, 4-n-propylphenol, 4-n-butylphenol, 4-n-amylphenol, 4-n-hexylphenol, thymol (5-methyl-2-isopropylphenol), 2-phenylphenol, 4-phenylphenol and 2-benzylphenol. Preference is given to using 2-phenylphenol as unchlorinated biocidal phenol.

Examples of chlorinated biocidal phenols are 4-chloro-3-methylphenol (PCMC, p-chloro-m-cresol), 4-chloro-3-ethylphenol, 2-n-amyl-4-chlorophenol, 2-n-hexyl-4-chlorophenol, 2-cyclohexyl-4-chlorophenol, 4-chloro-3,5-xylenol (PCMX, p-chloro-n-xylenol), 2,4-dichloro-3,5-xylenol (DCMX, dichloro-p-xylenol), 4-chloro-2-phenylphenol, 2-benzyl-4-chlorophenol, benzyl-4-chloro-m-cresol and 4-chlorobenzyldichloro-m-cresol. Preferred chlorinated biocidal phenols are 2-benzyl-4-chlorophenol, 4-chloro-3,5-xylenol, 2,4-dichloro-3,5-xylenol and, in particular, 4-chloro-3-methylphenol.

In this present case, phenol derivatives are understood as being phenol-derived compounds whose OH group is derivatized such that they do not contain any free OH group. The phenol derivatives are preferably phenol ethers, in particular containing aliphatic alcohols having from 1 to 6 carbon atoms. Phenoxyethanol may be mentioned as being a preferred example.

According to one embodiment according to the invention, an unchlorinated phenol can, as biocidal active compounds, be combined with two chlorinated phenols. A preferred example is the combination of 4-chloro-3-methylphenol, 2-phenylphenol and 2-benzyl-4-chlorophenol.

However, it has been found that specifically using unchlorinated phenol derivatives, in particular phenoxyethanol, together with biocidal phenols usually leads to a further improvement in the effect.

According to a preferred embodiment, it is possible to use, as biocidal active compounds, a chlorinated phenol, an unchlorinated phenol and an unchlorinated phenol derivative, in particular phenoxyethanol.

According to another preferred embodiment, it is possible to use, as biocidal active compounds, two different chlorinated phenols and one unchlorinated phenol derivative, in particular phenoxyethanol.

Particular preference is given to using, as biocidal active compounds, two different chlorinated phenols, one unchlorinated phenol and one unchlorinated phenol derivative, in particular phenoxyethanol. A particularly preferred example is the combination of 4-chloro-3-methylphenol, 2-phenylphenol, 2-benzyl-4-chlorophenol and phenoxyethanol.

Keratolytics are substances which exert an effect on keratins and, in the extreme case, are able to denature or decompose them. Suitable keratolytics for the compositions according to the invention are: organic acids, such as citric acid, formic acid and salicylic acid; and, in addition, urea, resorcinol, thioglycolic acid, sulphides and 5-fluorouracil. Salicylic acid is preferred in accordance with the invention.

The phenolic active compounds and the keratolytic can be formulated into a disinfectant in various ways, with liquid or solid formulations being suitable.

Solid formulations can be used, for example, in the form of powders, dusts, granules, etc. These customarily comprise carrier substances and/or auxiliary substances. The active compounds can be mixed with the carrier substances and/or auxiliary substances or be adsorbed on them.

However, preference is given to liquid formulations, for example in the form of emulsions, suspensions or, in particular, solutions. Liquid formulations can be used directly; however, preference is given to the formulations being concentrates which are as a rule diluted with water down to the concentration which is suitable before being used.

Emulsions are either of the water-in-oil type or of the oil-in-water type. They are prepared by dissolving the active compounds either in the hydrophobic phase or in the hydrophilic phase and homogenizing this phase with the solvent of the other phase using suitable emulsifiers and, where appropriate, additional auxiliary substances such as dyes, preservatives, antioxidants, photostabilizers and viscosity-increasing substances.

Hydrophobic phases (oils) which may be mentioned are: paraffin oils, silicon oils, natural vegetable oils, such as sesame oil, almond oil and castor oil, synthetic triglycerides, such as caprylic/capric acid diglyceride, a triglyceride mixture containing plant fatty acids of C₈₋₁₂ chain length or other specially selected natural fatty acids, partial glyceride mixtures of saturated or unsaturated, where appropriate also hydroxyl group-containing, fatty acids, mono- and diglycerides of the C₈/C₁₀ fatty acids, fatty acid esters, such as ethyl stearate, di-n-butyryl adipate, hexyl laurate and dipropylene glycol pelargonate, esters of a branched fatty acid of medium chain length with saturated fatty alcohols of C₁₆-C₁₈ chain length, isopropyl myristate, isopropyl palmitate, caprylic/capric esters of saturated fatty alcohols of C₁₂-C₁₈ chain length, isopropyl stearate, oleyl oleate, decyl oleate, ethyl oleate, ethyl lactate, waxy fatty acid esters, such as dibutyl phthalate and diisopropyl adipate, ester mixtures inter alia which are related to the latter, fatty alcohols, such as isotridecyl alcohol, 2-octyldodecanol, cetylstearyl alcohol and oleyl alcohol, and fatty acids such as oleic acid, and their mixtures.

Hydrophilic phases which may be mentioned are: water, alcohols such as propylene glycol, glycerol, sorbitol, ethanol, 1-propanol, 2-propanol and n-butanol, and also mixtures of these solvents.

Emulsifiers which may be mentioned are:

non-ionic surfactants, e.g. polyoxyethylated castor oil, polyoxyethylated sorbitan monooleate, sorbitan monostearate, glycerol monostearate, polyoxyethyl stearate and alkylphenol polyglycol ethers;
ampholytic surfactants such as di-Na-N-lauryl-β-iminodipropionate or lecithin;
anionic surfactants, such as fatty alcohol ether sulphates, C₈₋₁₈-alkyl sulphonates or sulphates, such as Na lauryl sulphate or secondary alkyl sulphonates (Mersolate®, preferably containing a medium alkyl chain length of 15 carbon atoms), and mono/dialkyl polyglycol ether orthophosphoric acid ester monoethanolamine salt;
cationic surfactants such as cetyltrimethylammonium chloride.

Further auxiliary substances which may be mentioned are: substances which increase viscosity and stabilize the emulsion, such as carboxymethylcellulose, methylcellulose and other cellulose and starch derivatives, polyacrylates, alginates, polyvinylpyrrolidone, polyvinyl alcohol, copolymers composed of methyl vinyl ether and maleic anhydride, polyethylene glycols, waxes and colloidal silicic acid, or mixtures of the abovemetioned substances.

Suspensions are prepared by suspending the active compound in a carrier liquid, where appropriate in the added presence of additional auxiliary substances such as wetting agents, dyes, preservatives, antioxidants and photostabilizers.

All the solvents and homogeneous solvent mixtures which are mentioned here are suitable for being used as carrier liquids.

The abovementioned surfactants may be cited as being wetting agents (dispersants).

Solutions are prepared by dissolving the active compound in a suitable solvent and, where appropriate, adding additives such as surfactants, solubilizers, acids, bases, buffer salts, antioxidants and preservatives.

Solvents which may be mentioned are: water, alcohols such as alkanols having from 1 to 4 carbon atoms (e.g. ethanol, 1-propanol, 2-propanol and n-butanol), aromatically substituted alcohols such as benzyl alcohol and phenyl ethanol; glycerol, glycols, propylene glycol, polyethylene glycols, polypropylene glycols, esters such as ethyl acetate, butylacetate and benzylbenzoate; ethers such as alkylene glycol alkyl ethers, such as dipropylene glycol monomethyl ether and diethylene glycol monobutyl ether; ketones such as acetone and methyl ethyl ketone, aromatic and/or aliphatic hydrocarbons, vegetable or synthetic oils, dimethylformamide (DMF), dimethylacetamide, N-methylpyrrolidone and 2-dimethyl-4-oxymethylene-1,3-dioxolane, and mixtures thereof.

While surfactants for use in the solutions can be the surfactants which are listed in connection with the emulsions, preference is given to anionic surfactants, in particular C₈₋₁₈-alkyl sulphonates or sulphates, e.g. secondary alkyl sulphonates (Mersolate®), preferably having a medium alkyl chain length of 15 carbon atoms.

Solubilizers which may be mentioned are: solvents which promote the dissolution of the active compound in the main solvent or prevent it being precipitated. Examples are polyvinylpyrrolidone, polyoxyethylated castor oil and polyoxyethylated sorbitan esters.

As further auxiliary substances or additives, the disinfectants according to the invention can also comprise softening agents and/or corrosion inhibitors.

Additives which are known from water treatment, e.g. phosphonic acids, catenate polyphosphates or low molecular weight polycarboxylic acids, are per se suitable, for example, for being used as softening agents.

In those cases in which the disinfectants according to the invention have still to be diluted for use, the constituents are customarily present in the following concentrations:

the biocidal phenols and, where appropriate, phenol derivatives are normally present in a total concentration of from 10 to 90% by weight, preferably of from 10 to 50% by weight, particularly preferably of from 15 to 40% by weight, based on the disinfectant.

The ratio of chlorinated biocidal phenols to unchlorinated biocidal phenols or phenol derivatives is preferably in the range of from 40:60 to 90:10, preferably of from 50:50 to 85:15, particularly preferably of from 65:35 to 82:18 (weight ratios based on the total weight of the biocidal phenols and/or phenol derivatives present, summarized as phenolic biocides in that which follows). The concentration ranges which are preferred for preferred phenolic biocides may be given here by way of example (that which is given is in each case the percent by weight based on the total weight of all the phenolic biocides which are present in the relevant composition):

4-chloro-3-methylphenol: from 30 to 80, preferably from 40 to 70, particularly preferably from 45 to 60%.

2-benzyl-4-chlorophenol: from 5 to 50, preferably from 10 to 40, particularly preferably from 15 to 30%.

2-phenylphenol: from 5 to 60, preferably from 10 to 50, particularly preferably from 13 to 45%.

Phenoxyethanol: from 3 to 30, preferably from 5 to 25, particularly preferably from 10 to 20%.

According to a particularly preferred embodiment, the disinfectant according to the invention comprises, as biocidal phenols, a combination of 4-chloro-3-methylphenol, 2-benzyl-4-chlorophenol and 2-phenylphenol, which can, where appropriate and particularly preferably, comprise phenoxyethanol as well. The active compound concentrations are then in the abovementioned ranges.

The keratolytic is generally employed in the disinfectants according to the invention in a ratio by weight to the phenolic biocides of from 50:50 to 10:90, preferably of from 40:60 to 15:85, particularly preferably of from 30:70 to 20:80. Based on the finished disinfectant (usually a concentrate), the concentrations of keratolytic are as a rule from 1 to 30% by weight, preferably from 3 to 20% by weight, particularly preferably from 5 to 18% by weight.

The disinfectants according to the invention preferably comprise surfactants, usually in concentrations of from 3 to 20% by weight, preferably from 5 to 20% by weight, particularly preferably from 5 to 15% by weight.

The solvent content can be varied within wide limits. In the case of concentrates, the nonaqueous solvents, preferably the abovementioned alkanols having from 1 to 4 carbon atoms (e.g. ethanol, 1-propanol, 2-propanol and n-butanol) are usually employed in quantities of from 15 to 65% by weight, preferably of from 20 to 60% by weight, particularly preferably of from 30 to 50% by weight. Furthermore, the compositions preferably comprise water, usually from 0 to 30% by weight, preferably from 5 to 25% by weight, particularly preferably from 5 to 20% by weight.

The disinfectants which are described above in detail are concentrates which are as a rule diluted with water for use. Ready-to-use solutions usually contain from 0.5 to 20% by volume, preferably from 1 to 10% by volume, particularly preferably from 1 to 5% by volume, of disinfectant concentrate. The concentration which is used can be varied depending on the purpose. For example, the exposure times which are required for a satisfactory effect are shorter when more highly concentrated compositions are employed.

Typical exposure times are, for example, from 0.5 to 5 hours, preferably from 1 to 4 hours.

The disinfectants according to the invention are suitable for controlling parasitic protozoa and helminthen which are found in animal husbandry and animal breeding in the case of productive animals, breeding animals, zoo animals, laboratory animals, experimental animals and pet animals. In this connection, the disinfectants are effective, in particular, against the persistent stages (extracellular cyst stages).

The parasitic protozoa include:

Sarcomastigophora (Rhizopoda) such as Entamoebidae, e.g. Entamoeba histolytica, Hartmanellidae e.g. Acanthamoeba sp., and Hartmanella sp.

Apicomplexa (Sporozoa), in particular coccidia, such as Eimeridae e.g. Eimeria acervulina, E. adenoids, E. alabahmensis, E. anatis, E. anseris, E. arloingi, E. ashata, E. aubumensis, E. bovis, E. brunetti, E. canis, E. chinchillae, E. clupearum, E. columbae, E. contorta, E. crandalis, E. debliecki, E. dispersa, E. ellipsoidales, E. falciformis, E. faurei, E. flavescens, E. gallopavonis, E. hagani, E. intestinalis, E. iroquoina, E. irresidua, E. labbeana, E. leucarti, E. magna, E. maxima, E. media, E. meleagridis, E. meleagrimitis, E. mitis, E. necatrix, E. ninakohlyakimovae, E. ovis, E. parva, E. pavonis, E. perforans, E. phasani, E. piriformis, E. praecox, E. residua, E. scabra, E. spec., E. stiedai, E. suis, E. tenella, E. truncata, E. truttae, E. zuernii, Globidium spec., Isospora belli, I. canis, I. felis, I. ohioensis, I. rivolta, I. spec., I. suis, Neospara caninum, Cystisospora spec., Cryptosporidium spec. as well as Toxoplasmadidae e.g. Toxoplasma gondii, as well as Sarcocystidae e.g. Sarcocystis bovicanis, S. bovihominis, S. ovicanis, S. ovifelis, S. spec. and S. suihominis.

Mastogophora (Flagellata) such as Giardia lamblia and G. canis.

In addition, Myxospora and Microspora e.g. Glugea spec. and Nosema spec.

The helminths include trematodes, tape worms and nematodes.

The trematodes include, e.g., pathogens belonging to the families/genera: Fasciola, Paramphistomum, Dicrocoelium and Opisthorchis;

The tape worms include, e.g., pathogens belonging to the families/genera Moniezia, Anoplocephala, Diphyllobothrium, Taenia, Echinococcus, Dipylidium, Raillietina, Choanotaenia and Echinuria,

the nematodes include, e.g., pathogens belonging to the families/genera: Stronglyoides, Haemonchus, Ostertagia, Trichostrongylus, Cooperia, Nematodirus, Trichuris, Oesophagostomum, Chabertia, Bunostomum, Toxocara vitulorum, Ascaris, Parascaris, Oxyuris, Oesophagostumum, Globocephalus, Hyostrongylus, Spirocerca, Toxascaris, Toxocara, Ancylostoma, Uncinaria, Capillaria, Prosthogonimus, Amidostomum, Capillaria, Ascaridia, Heterakis, Syngamus and Acanthocephala.

Apart from being used against protozoa and helminths, the disinfectants according to the invention can also be used, for example, for controlling

bacteria, such as clostridia, Escherichia coli, Salmonella spec., Pseudomonas spec. Staphylococcus spec. and Mycobacterium tuberculosis, and
yeasts, such as Candida albicans, and fungal infections.

The productive and breeding animals include mammals, such as cattle, horses, sheep, pigs, goats, camels, water buffalo, donkeys, mules, zebras, rabbits, fallow deer, reindeer, animals prized for their fur such as mink, chinchilla and racoon, birds, such as hens, geese, turkeys, ducks, pigeons and pheasants, and also bird species for domestic and zoo husbandry.

The laboratory and experimental animals include mice, rats, guinea pigs, golden hamsters, dogs and cats.

The pet animals include dogs and cats.

The disinfectants according to the invention are especially suitable for being used in large-scale animal husbandry, in particular, for example, in poultry breeding (for example in fowl raising), calf raising or pig raising.

### EXAMPLES

### I. Formulation Examples

### General Preparation Protocol

The phenols are dissolved, with stirring, in the alcohol or alcohol mixture. Water, where appropriate phenoxyethanol, salicylic acid and alkane sulphonate (Mersolat® W93) are added to the resulting alcoholic solution and dissolved during continuous stirring.

| | Example No. | | | | | | |
|---|---|---|---|---|---|---|---|
| Formulation | 1 | 2 | 3 | 4 | 5 | 6 | 7 |
| Constituents | [g] | [g] | [g] | [g] | [g] | [g] | [g] |
| 1-Propanol | 25 | 25 | 25 | 25 | 25 | 25 | 25 |
| 2-Propanol | 15 | 15 | 15 | 15 | 15 | 15 | 15 |
| 4-Chloro-3- | 15 | 15 | 15 | 15 | 15 | 15 | 15 |
| methylphenol | | | | | | | |
| 2-Phenylphenol | 10 | 5 | 5 | 5 | 5 | 5 | 10 |
| 2-Benzyl-4- | | 5 | 5 | 5 | 5 | 5 | |
| chlorophenol | | | | | | | |
| Sec. alkyl sulphonate, | 10 | 10 | 10 | 10 | 15 | 10 | 10 |
| medium chain length: | | | | | | | |
| C_{15 (Mersolat ® W93)} | | | | | | | |
| Salicylic acid | 10 | 10 | 10 | 15 | 10 | 10 | 10 |
| Phenoxyethanol | 5 | | | | | 5 | 5 |
| Water | to | to | to | to | to | to | to |
| | 100 | 100 | 100 | 100 | 100 | 100 | 100 |

### Materials and Methods for the Biological Test Procedures

The testing of the disinfectant formulations followed both the German Veterinary Society's guidelines for testing chemical disinfectants and the published Daugschies et al. (2002) methods.

### 1. Obtaining the Oocysts

The “Houghton” strain of Eimeria tenella (Institute for Animal Health, Compton Laboratories, Near Newbury, Berks. RG16 0NN, UK) was used for the testing. 14-day-old male laying-type chicks (strain LSL) supplied by Brinkschulte were used for propagating and isolating the oocysts. The animals were supplied to the animal centre as one-day-old chicks and kept coccidia-free in the animal centre, using chick growing ration without coccidiostats and water ad libitum, until the beginning of the experiment. For the infection, the animals were inoculated individually, by gavage, with 13 000 oocysts in 0.2 ml of water. On the 7th day after the infection, the animals were sacrificed painlessly with carbon dioxide, after which the oocysts were isolated from the coeca and placed in 2% potassium dichromate solution for 4 days to cause them to sporulate. On the day of the experiment, the potassium dichromate was washed out of the oocyst suspension by centrifuging 3 times, in each case at 2000 rpm for 5 min, and resuspending the pellet in water. After the 3rd centrifugation, the oocyst suspension was adjusted to a concentration of 25 000 oocysts per ml of stock solution using a Bürker chamber.

### 2. Disinfecting the Oocysts (Lysis Test)

The disinfectants to be tested were prepared, in twice the concentration for use in water (double-distilled), immediately prior to each test run. The stock solution was used to prepare 1%, 2% and 4% solutions:

100 μl of stock solution+4900 μl of dist. water (=1%, double concentration!)

200 μl of stock solution+4800 μl of dist. water (=2%, double concentration!)

400 μl of stock solution+4600 μl of dist. water (=4%, double concentration!)

Each formulation was determined in duplicate in each experiment. Per assay, 0.5 ml of oocyst suspension (=12 500 oocysts=100%) and 0.5 ml of the disinfectant solution were mixed in each of two 25 ml glass beakers. For the internal, untreated experimental control (IC), 0.5 ml of water was mixed with 0.5 ml of oocyst suspension. During the exposure time (1 h, 2 h or 3 h), the suspensions were kept on a shaker which was in gentle motion.

After the given exposure time had come to an end, the entire contents of the beakers were in each case transferred to a 2000 ml Erlenmeyer flask. The beakers were subsequently rinsed with water and the Erlenmeyer flasks were made up to 1500 ml with the rinsing water. The flask contents were mixed and, after a 24-hour period of sedimentation at room temperature, the supernatants were poured off apart from 100 ml. The sediment was transferred to a 200 ml centrifuge tube, made up to 200 ml with water and left to stand overnight. On the following day, the supernatant was aspirated down to approx. 30 ml, after which the sediment was transferred to a 50 ml centrifuge tube and made up to 50 ml with water. After mixing by inversion, in each case 6×200 μl were pipetted, per disinfection assay, into 6 wells in a 96-well microtitre plate. The plates were stored at 4° C. in a refrigerator until they were evaluated microscopically. The oocysts which were present were counted using an inverse microscope at 200 times magnification. Only intact oocysts, without any recognizable change in their outer wall, were counted.

### 3. Calculating the “Lysis Rate”

The arithmetic means of the numbers of oocysts recovered from two microtitre plates (plate 1 and plate 2, duplicate determination) per disinfection assay constituted the basis for calculating the lysis rate. In this connection, the recovery rates (RRs) of the individual assays of the disinfectants were related to the recovery rate in the untreated control (IC) (rel. RW): rel. RR [%]=RR of disinfected oocysts×100/RR of control (IC) [%]. The activities of the disinfectant formulations manifested themselves in the “rate of lysis” of the oocysts and were given by the difference from 100: lysis rate [%]=100-rel. RR [%].

### 4. Main In-Vivo Test (Infection Test Using Hen Chicks)

In order to establish whether disinfected oocysts have really been killed and lost their infectivity, it is also necessary, in accordance with the German Veterinary Society's (DVG's) guidelines, to carry out an infection test on hen chicks using the disinfected oocysts.

In our experiments, approx. 14-day-old LSL lay-type chicks were infected with disinfected oocysts; for this, the oocyst suspension which was obtained after disinfecting and stopping the reaction was diluted down to a theoretical dose of 2000/ml using the dilution factor which was determined for the corresponding controls. To do this, the values for the counting of the 96-well microtitre plates from the in-vitro lysis test were used in order to determine how many ml of suspension from the IC 50 ml tube contained 2000 sporulated oocysts. The volume which was determined in this connection was also taken, for the infection, from all the other disinfection assays irrespective of the number of oocysts which were present in the volume. The volume administered per chick was 0.5 ml. In addition to the internal experimental control, an infection control from the original oocysts suspension was adjusted to 2000 oocysts/ml in a volume of 0.3 ml. On day 7 after the infection, the animals were sacrificed painlessly using carbon dioxide.

The following criteria were taken into consideration for assessing the activity: weight increase from the beginning of the experiment to the end of the experiment, infection-related mortality rate, macroscopic assessment of the faeces, on days 6 and 7 post-infection, with regard to diarrhoea and blood discharge (rating 0 to 6), macroscopic assessment of the intestinal mucosa, in particular of the coeca, for lesions (rating 0 to 6) and oocyst excretion. The number of oocysts in the excrement was determined using a McMaster counting chamber. The individual findings were related to the untreated and uninfected control groups and an overall rating was calculated (Haberkom and Greif 1999).

Experimental results which were obtained using formulations according to the invention are given by way of example in the following tables. The superior activity of the novel formulations as compared with that of a comparison formulation which was not in accordance with the invention can be seen, in particular, by the reduction in oocyst excretion.

In the tables for Examples B, E, F and H, the statements in the “treatment” column have the following meanings:

| | |
|---|---|
| uninf. control = | uninfected control group |
| inf. control = | infected control group |
| Ex. No. 1 = | Experiment No. of formulation |

The “dead” column gives the number of dead animals/number of animals used in the experiment. The “weight in % of the uninf. control” column gives the ratio of the weight of the treated animals to the weight of the uninfected control group. The “diarrhoea”, “lesions” and “oocysts” columns provide detailed information with regard to the effect. The overall assessment is rated in the “% efficacy” column; 0% means no effect while 100% means full effect.

### Results of the Biological Test Procedures

### Biological Example A

### Testing of Different Disinfectant Formulations (4%) Against Eimeria tenella Oocysts In Vitro After an Exposure Time of 3 Hours

| | Number of | | | | |
|---|---|---|---|---|---|
| Treatment | oocysts | | Average | | Lysis |
| Formulation | Plate 1 | Plate 2 | oocysts | Rel. recovery rate % | rate |
| Ex. 1 | 0 | 0 | 0 | 0.0 | 100 |
| Ex. 2 | 0 | 0 | 0 | 0.0 | 100 |
| Ex. 3 | 5 | 8 | 6.5 | 15.3 | 84.7 |
| Neopredisan** | 32 | 27 | 29.5 | 69.4 | 30.6 |
| Control | 49 | 36 | 42.5 | 100 | 0.0 |

### Biological Example B

### Testing of Different Disinfectant Formulations (4%) Against Eimeria tenella on Hen Chicks In Vivo After an Exposure Time of 3 Hours

| | | Weight in | | | | Oocysts | |
|---|---|---|---|---|---|---|---|
| | | % of the | Diarrhoea | Lesions | | in % of | |
| Treatment | | uninf. | Score | Score | | the inf. | % |
| Formulation | Dead | control | 1-6 | 1-6 | Oocysts | control | efficacy |
| Uninf. control | 0/6 | 100 | 0 | 0 | 0 | 0 | 100 |
| Infected control | 0/3 | 92 | 0-4 | 6 | 45 000 | 100 | 0 |
| Ex. 2 | 0/3 | >100 | 0 | 2 | 200 | 0.4 | 92 |
| Ex. 3 | 0/3 | 79 | 0 | 0 | 0 | 0 | 92 |
| Ex. 4 | 0/3 | 90 | 0 | 0 | 200 | 0.4 | 92 |
| Ex. 5 | 0/3 | 90 | 0 | 1.3 | 0 | 0 | 85 |
| Ex. 7 | 0/3 | 93 | 0 | 0 | 0 | 0 | 100 |
| Neopredisan** | 0/3 | >100 | 0 | 0 | 35 000 | 78 | 54 |
| Ki | 0/3 | 88 | 0-4 | 6 | 214 000 | >100 | 0 |

*not in accordance with the invention
**commercial product

### Biological Example C

### Testing of Different Disinfectant Formulations (1%, 2% and 4%) Against Eimeria tenella Oocysts in Vitro After an Exposure Time of 3 Hours

| | Number of | | | | |
|---|---|---|---|---|---|
| Treatment | oocysts | | Average | | Lysis |
| Formulation | Plate 1 | Plate 2 | oocysts | Rel. recovery rate % | rate |
| Ex. 3, 1% | 0.2 | 15.0 | 7.6 | 25.9 | 74.1 |
| Ex. 3, 2% | 0.3 | 0.3 | 0.3 | 1.1 | 98.9 |
| Ex. 3, 4% | 0.0 | 0.8 | 0.4 | 1.4 | 98.6 |
| Ex. 6, 1% | 33.5 | 26.8 | 30.2 | 100 | 0 |
| Ex. 6, 2% | 7.7 | 16.8 | 12.3 | 41.8 | 58.2 |
| Ex. 6, 4% | 0.0 | 0.0 | 0.0 | 0 | 100 |
| Ex. 7, 1% | 22.2 | 36.2 | 29.2 | 99.4 | 0.6 |
| Ex. 7, 2% | 8.3 | 8.3 | 8.3 | 28.4 | 71.6 |
| Ex. 7, 4% | 4.3 | 5.8 | 5.1 | 17.3 | 82.7 |
| Control | 28.7 | 30.0 | 29.3 | 100 | 0 |

### Biological Example D

### Testing of Different Disinfectant Formulations (4%) Against Eimeria tenella Oocysts In Vitro After an Exposure Time of 1, 2 or 3 Hours

| Treatment | Number of oocysts | | Average | | Lysis |
|---|---|---|---|---|---|
| Formulation | Plate 1 | Plate 2 | oocysts | Rel. recovery rate % | rate |
| Ex. 3, 1 h | 1.0 | 0.2 | 0.6 | 2.0 | 98.0 |
| Ex. 3, 2 h | 0.2 | 0.8 | 0.5 | 1.7 | 98.3 |
| Ex. 3, 3 h | 0.0 | 2.5 | 1.3 | 4.2 | 95.8 |
| Ex. 6, 1 h | 0.0 | 0.0 | 0.0 | 0.0 | 100 |
| Ex. 6, 2 h | 0.0 | 0.0 | 0.0 | 0.0 | 100 |
| Ex. 6, 3 h | 0.0 | 0.0 | 0.0 | 0.0 | 100 |
| Ex. 7, 1 h | 0.7 | 1.2 | 0.9 | 3.1 | 96.9 |
| Ex. 7, 2 h | 4.7 | 9.2 | 6.9 | 23.2 | 76.8 |
| Ex. 7, 4 h | 1.5 | 0.5 | 1.0 | 3.4 | 96.6 |
| Control | 28.8 | 30.7 | 29.8 | 100 | 0 |

### Biological Example E

### Testing of Different Disinfectant Formulations (4%) Against Eimeria tenella on Hen Chicks In Vivo After an Exposure Time of 3 Hours

| | | Weight in | | | | Oocysts | |
|---|---|---|---|---|---|---|---|
| | | % of the | Diarrhoea | Lesions | | in % of | |
| Treatment | | uninf. | Score | Score | | the inf. | |
| Formulation | Dead | control | 1-6 | 1-6 | Oocysts | control | % efficacy |
| Uninf. control | 0/6 | 100 | 0 | 0 | 0 | 0 | 100 |
| Infected control | 0/3 | 94 | 0-2 | 4.6 | 106 000 | 100 | 0 |
| Ex. 3 | 0/3 | 92 | 0 | 0 | 3000 | 3 | 91 |
| Ex. 6 | 0/3 | >100 | 0 | 0 | 6000 | 6 | 91 |
| Ex. 7 | 0/3 | 94 | 0 | 0 | 2000 | 2 | 91 |

### Biological Example F

### Testing of Different Disinfectant Formulations (4%) Against Eimeria tenella Oocysts on Hen Chicks In Vivo After an Exposure Time of 1 Hour

| | | Weight in | | | | Oocysts | |
|---|---|---|---|---|---|---|---|
| | | % of the | Diarrhoea | Lesions | | in % of | |
| Treatment | | uninf. | Score | Score | | the inf. | |
| Formulation | Dead | control | 1-6 | 1-6 | Oocysts | control | % efficacy |
| Uninf. control | 0/6 | 100 | 0 | 0 | 0 | 0 | 100 |
| Infected control | 0/3 | 84 | 0 | 6 | 1800 | 100 | 0 |
| Ex. 3 | 0/3 | >100 | 0 | 0 | 3000 | >100 | 45 |
| Ex. 6 | 0/3 | 98 | 0 | 0 | 0 | 0 | 100 |
| Ex. 7 | 0/3 | >100 | 0 | 0 | 2600 | >100 | 45 |

### Biological Example G

### Testing of Disinfectant Formulation Ex. 6 (1%) Against Eimeria tenella Oocysts In Vitro, as Compared with Neopredisan (1%), After Exposure Times of 1, 2 and 3 Hours

| Treatment | Number of oocysts | | Average | Rel. | Lysis |
|---|---|---|---|---|---|
| Formulation | Plate 1 | Plate 2 | oocysts | recovery rate % | rate |
| Ex. 6, 1 h | 2.17 | 6.67 | 4.42 | 13.3 | 86.7 |
| Ex. 6, 2 h | 2.50 | 1.83 | 2.17 | 6.5 | 93.5 |
| Ex. 6, 3 h | 4.0 | 10.00 | 7.00 | 21.1 | 78.9 |
| Neopredisan 1 h | 26.33 | 24.33 | 25.33 | 76.2 | 23.8 |
| Neopredisan 2 h | 11.50 | 26.33 | 18.92 | 56.9 | 43.1 |
| Neopredisan 3 h | 24.17 | 20.17 | 22.17 | 66.7 | 33.3 |
| Control | 29.00 | 37.50 | 33.25 | 100.0 | 0.0 |

### Biological Example H

### Testing of Disinfectant Formulations Ex. 6 (1%, 4%), as Compared with Neopredisan® (1%, 4%), Against Eimeria tenella Oocysts on Hen Chicks In Vivo After an Exposure Time of 1 Hour

| | | Weight in | | | | Oocysts | |
|---|---|---|---|---|---|---|---|
| | | % of the | Diarrhoea | Lesions | | in % of | |
| Treatment | | uninf. | Score | Score | | the inf. | |
| Formulation | Dead | control | 1-6 | 1-6 | Oocysts | control | % efficacy |
| Uninf. control | 0/6 | 100 | 0 | 0 | 0 | 0 | 100 |
| Infected control | 0/6 | 82 | 0-2 | 6 | | 100 | 0 |
| Ex. 6 1%, | 0/3 | >100 | 0 | 4 | | 14 | 42 |
| Ex. 6 4% | 0/3 | >100 | 0 | 0 | | 1.4 | 92 |
| Neopredisan | 0/3 | >100 | 0-2 | 6 | | 64 | 8 |
| 1% | | | | | | | |
| Neopredisan | 0/3 | 98 | 0 | 2 | | 87 | 42 |
| 4% | | | | | | | |

### REFERENCES

Böhm, R. (2000): Liste der nach der Richtlinien der DVG geprüften und als wirksam befundenen Desinfektionsmittel für die Tierhaltung (Handelspräparate) [List of the disinfectants for animal husbandry (commercial preparations) which have been tested in accordance with the DVG (German Veterinary Society) Guidelines and have been found to be effective]. Deutsches Tierärzteblatt 9/2000.
Daugschies, A., Böse, R., Marx, J., Teich, K., Friedhoff, K T (2002): Development and application of a standardization assay for chemical disinfection of coccidia oocysts. Vet. Parasitol. 103(4): 299-308.
Mouafo, A. N., Richard, F., Entzeroth, R. (2000): Observation of sutures in the oocyst wall of Eimeria tenella (Apicomplexa). Parasitol. Res. 86: 1015-1017.
Eckert, J. (2000): Parasitenstadien als umwelthygienisches Problem [Parasite stages as a problem of environmental hygiene]. In: Veterinärmedizinische Parasitologie [Veterinary Parasitology] 94-119. Eds.: Rommel, Eckert, Kutzer, Körting and Schnieder. Parey Buchverlag Berlin.
Haberkorn, A., Greif, G. (1999): Animal Models of Coccidia Infection. In: Handbook of Animal Models of Infection, Chapter 99. Academic Press.

1. A disinfectant which comprises
(a) a chlorinated biocidal phenol,
(b) another chlorinated or unchlorinated biocidal phenol,
(c) an unchlorinated biocidal phenol and/or phenol derivative, and
(d) a keratolytic.

2. The disinfectant according to claim 1, which comprises two different chlorinated biocidal phenols and an unchlorinated biocidal phenol.

3. The disinfectant according to claim 1, which comprises an unchlorinated biocidal phenol derivative.

4. The disinfectant according to claim 1, in which the chlorinated biocidal phenol(s) is/are selected from the group: 4-chloro-3-methylphenol (PCMC, p-chloro-m-cresol), 4-chloro-3-ethylphenol, 2-n-amyl-4-chlorophenol, 2-n-hexyl-4-chlorophenol, 2-cyclohexyl-4-chlorophenol, 4-chloro-3,5-xylenol (PCMX, p-chloro-n-xylenol), 2,4-dichloro-3,5-xylenol (DCMX, dichloro-p-xylenol), 4-chloro-2-phenylphenol, 2-benzyl-4-chlorophenol, benzyl-4-chloro-m-cresol and 4-chlorobenzyldichloro-m-cresol.

5. The disinfectant according to claim 1, in which the unchlorinated biocidal phenol(s) is/are selected from the group: 2-methylphenol, 3-methylphenol, 4-methylphenol, 4-ethylphenol, 2,4-dimethylphenol, 2,5-dimethylphenol, 3,4-dimethylphenol, 2,6,-dimethylphenol, 4-n-propylphenol, 4-n-butylphenol, 4-n-amylphenol, 4-n-hexylphenol, thymol (5-methyl-2-isopropylphenol), 2-phenylphenol, 4-phenylphenol and 2-benzylphenol.

6. The disinfectant according to claim 1, in which the unchlorinated biocidal phenol derivative is a phenol ether, in particular phenoxyethanol.

7. The disinfectant according claim 1, in which the keratolytic is selected from the group consisting of organic acids, urea, resorcinol, thioglycolic acid, sulphides, and 5-fluorouracil.

8. The disinfectant according to claim 7, in which the keratolytic is salicylic acid.

9. Use of the disinfectant according to claim 1 for controlling parasitic protozoa, helminths, bacteria and/or yeasts.

10. The use according to claim 9, for controlling persistent stages of parasitic protozoa and/or helminths.
